(19) United States
(12) Patent Application Publication
(10) Pub. No.: US 2003/0229606 A1
(43) Pub. Date: Dec. 11, 2003

(54) Network-aided instruction system and method

(76) Inventor: Jen-Hwang Weng, Jungli City (TW)

Correspondence Address: DENNISON, SCHULTZ & DOUGHERTY, 1745 JEFFERSON DAVIS HIGHWAY, ARLINGTON, VA, 22202, US

(21) Appl. No.: 10/158,148

(22) Filed: May 31, 2002

(51) Int. Cl. G06F 17/30; G06F 7/00

(52) U.S. Cl. 707/1

(57) ABSTRACT

A Web site system and method provides network-aided instructions. The Web site system offers at least one instruction text, at least one text remark, a selection mechanism and an inquiry mechanism to a plurality of users to participate online network-aided instruction activities. The instruction text includes a plurality of text units, each of which has an identification data stored in a database of the Web site system. The text units are transmitted to a user end in Web page formats through the network, and are assembled and presented according to the original format of the instruction text. The test remark is the remark for each text unit or a keyword in the instruction text. The selection mechanism is downloaded along with the instruction text Web pages to the user ends. Users, based on instruction requirements, may choose a single (or multiple) selection on the instruction text Web pages to search and inquire the text unit or keyword, and designate a remark category to search and inquire related remarks. The selection mechanism can retrieve identification data of the selected text units or character strings of the selected keyword. The inquiry mechanism resides in the Web site system end for receiving the remark category designated by the user or the identification data retrieved by the selection mechanism (or a character string of the keyword), and searches the remarks of the text remark and transfers and presents the obtained remark contents in Web page formats through the network to the users to enable the users to participate the assist instruction activities.

### FIELD OF THE INVENTION

The present invention relates to a network-aided instruction system and a method that includes a Web site system to provide online network-aided instructions to a plurality of users.

### BACKGROUND OF THE INVENTION

The rising of the Internet has accelerated the arrival of information revolution. Availability of broadband networks through which broadband networks can transmit rich and dynamic multimedia information further unveils the coming of “knowledge economic era”. In addition, reading software for multimedia information is well developed and has become mature now. Hence, to transmit dynamic multimedia information through networks is practical and feasible at present. For instance, distant learning that employs networks to transmit video and audio instruction contents to perform multimedia instruction activities is getting more and more common nowadays.

Distant learning is a technique that utilizes far-reaching capability of networks to overcome regional barrier and constraints incurred to traditional learning methods, and adds multimedia instruction materials to enhance learning effect. However, with teacher's roles virtualized among students and colleagues, true value or effect of distant learning is still a debatable question. While distance learning eliminates the restriction of classrooms, it also tends to distant the relationship between teachers and students. Therefore, how to change the present teaching methods so that advantages of distant learning can be gained without trading off benefits of traditional teachings has become a subject deserving thorough considerations and thought.

Traditional instructions employ blackboards as media to present instruction contents and books as instruction carriers. Teachers write on the blackboards to highlight key points, and each student has a textbook to follow and compare with what teachers have been lecturing. It is not unusual that students could lose what the teachers have been talking while they are busily browsing the textbooks. Another problem that often happens is that teachers write supplemental materials on the blackboards, and students busily jot down on notebooks what have been written on the blackboards. When the teachers have finished writing, some students could be left behind without finishing the writing. In many occasions, teachers cannot afford to waste time by waiting for all of the students to complete writing notebooks, and would start lecturing while some of the students are still writing. Then, those students who have not finished the writing of their notebooks tend to lose the lecturing. Such a type of shortcomings is usually seen in traditional teaching and lecturing. Also, it is easy to see that book-based instruction cannot include multimedia materials and, on the other hand, blackboard instruction cannot present multimedia contents. However, great value of multimedia instruction materials to learning has been well recognized. Such a trend of multimedia instructions can be proved by availability and popularity of video and audio instruction materials in the market. For some traditional teaching institutions that implement multimedia instructions, supplementing instructions with the multimedia-deficient books or blackboards by using audio tape players or TVs becomes popular. In this situation, students have to mingle alternately with materials contained in books, audiotapes and videotapes. Definitely, such a learning style is making confusion and ineffective. Teachers also have to handle and manage frequently among books, audiotapes and videotapes. It thus creates a lot of distractions and the teachers have to spend a lot of energy on non-teaching chores. As a result, effectiveness for both teachers' teaching and students' learning is affected adversely. Therefore, it can be seen that traditional instruction methods need to be radically overhauled so as to meet increasing demands of the information age.

In view of aforesaid disadvantages, some people have employed Computer Aided Instruction (CAI) to overcome those problems. The common type of CAI is an optical disk that can provide multimedia materials and can improve interactive learning functions. However, current teachers rarely use them for teaching. Instead, those CAI materials are mostly used by students as a self-learning tool. Regarding most CAI materials existing in the market, instruction contents are usually not transmitted through networks so that students can only use optical disks individually. Without guidance under teachers, the benefits of those CAI materials to students' learning are limited. Various reasons may cause teachers reluctant to adopt the CAI methods. These reasons include lacking in projecting equipment (due to the cost), limited optical storage capacity, lack of instruction materials and so on. Moreover, the reasons that the conventional CAI methods cannot randomly select contents or search remarks from the accompanying optical disks, operations of searching and retrieving thereof has to follow preset routes and cannot be freely decided by teachers/operators, and instruction directions are set or limited by the contents of optical disks, which are all indicators that there is still room for improving those CAI methods.

### SUMMARY OF THE INVENTION

In view of aforesaid disadvantages, the object of the invention is to employ networks as channels of instruction contents, to couple with distant learning for overcoming shortcomings of traditional instruction methods and conventional CAI methods, and to provide an alternative learning method for benefiting the education systems.

The invention employs a Web site system to carry out network-aided instructions. The Web site system has a database to store contents of instruction texts and text remarks, and provides a selection mechanism and an inquiry mechanism. The instruction texts include multimedia contents that can be transmitted through networks to teaching ends. Teachers may lecture by means of projection. During lecturing, teachers can randomly select key contents and freely designate inquiry categories. The selection mechanism can retrieve selected key contents or identification data of the key contents, search and inquire remarks through the inquiry mechanism, and present the obtained remark contents through the networks at the teaching ends for assisting instruction activities. As teaching data are stored in the database, searching and inquiring can be flexible and easy, in which the inquiring can include cross inquiry, linkage inquiry or the likes. Also, almost all allowable methods for searching and inquiring database can be implemented.

The invention utilizes Web pages as the carrier of instruction data. The Web pages may include multimedia contents, and may be projected during lecturing. Students do not need to switch between books and blackboards. Because instruction contents are transmitted through networks, teachers and students do not need to carry optical disks. And, there is no capacity limitation for the database needed to store instruction materials. Methods of employing database techniques to search or inquire remarks become much flexible. Lecturing based on text contents and instant inquiry of remarks can free teachers from a lot of painstaking preparations. Remark contents may be presented on Web pages, thus teachers do not need to write on the blackboards. Teachers can randomly select desired objects to process specific inquiries, and thus can actively control lecturing directions. Inquiry categories are not restricted by preset inquiry routes or paths. Multiple selection of objects may be done to process cross inquiry, hence lecturing under the invention can be proceeded more flexibly and dynamically. In addition, instruction materials are managed in a centralized fashion so as to allow future additions, modifications, updates or deletions of data easily. As data are gathered in one place and inquiry indexes are coded uniformly, inquiry scope can be expanded across different text contents or different remark contents. Taking English teaching as an example, in the event of inquiring related to grammar concepts represented by uniformed codes, the uniformed codes may be used as inquiry indexes to cross different text contents (different books or teaching material contents) or different remark contents (different dictionary or topic libraries) to process inquiries upon the grammar concepts. In addition, the uniformed codes based on the root form of a single word or phrase may also be used to cross different text contents or remark contents while processing remark inquiry for the single word or phrase.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a schematic view of an environment of the invention;

FIG. 2 is a system architecture diagram of the invention;

FIG. 3 is a flow chart of the selection mechanism of the invention;

FIG. 4 is a flow chart of the inquiry mechanism of the invention;

FIG. 5 is a flow chart of the method of the invention; and

FIG. 6 is a block diagram of the apparatus of the invention.

### DETAILED DESCRIPTION OF THE INVENTION

The invention aims at providing a network-aided instruction system and method. The Web site system provides at least an instruction text, at least a text remark, a selection mechanism and an inquiry mechanism to a plurality of users to do online network-aided instruction activities.

The instruction text has contents including characters, pictures, audio signals, animations or other multimedia objects. The instruction text further consists of a plurality of text units. Taking English teaching materials as examples, the text units may be dividable units such as paragraphs, sentences, pictures or multimedia objects of the teaching materials. Every text unit is given an identification data and is stored in a database of the Web site system. The text units are transmitted in Web page formats to user ends and are assembled sequentially to their original formats of instruction texts for presentation.

The text remark is a remark for each text unit or keyword that can be stored in the database of the Web site system, and has contents including characters, pictures, audio signals, animations or other multimedia objects. Taking English teaching materials as an example of the instruction text, if the text unit is assigned as each sentence of the teaching materials, the remark related to the text unit can be grouped in various categories such as grammar concept of the sentence, translation of the sentence or test questions related to the grammar of the sentence, etc. If the keyword is a single word or a phrase, then remarks relate to the keyword may also be grouped in various categories, such as meaning of the word, pronunciation, root, prefix or literary references, etc.

The selection mechanism is downloaded to the user ends along with the instruction text Web pages. Users, based on instruction requirements, may choose single (or multiple) selection of the text unit or keyword on the Web page, and designate remark category to search or inquire remark contents. The selection mechanism retrieves the identification data or character strings of the selected keyword of the choosing text unit.

The inquiry mechanism resides in the Web site system end for receiving the remark category designated by the users or the identification data retrieved by the selection mechanism (or character string of the keyword), and searches the remark of the text remark and transfers and presents the obtained remark contents in Web page formats through the networks to the users to enable the users to participate the instruction activities.

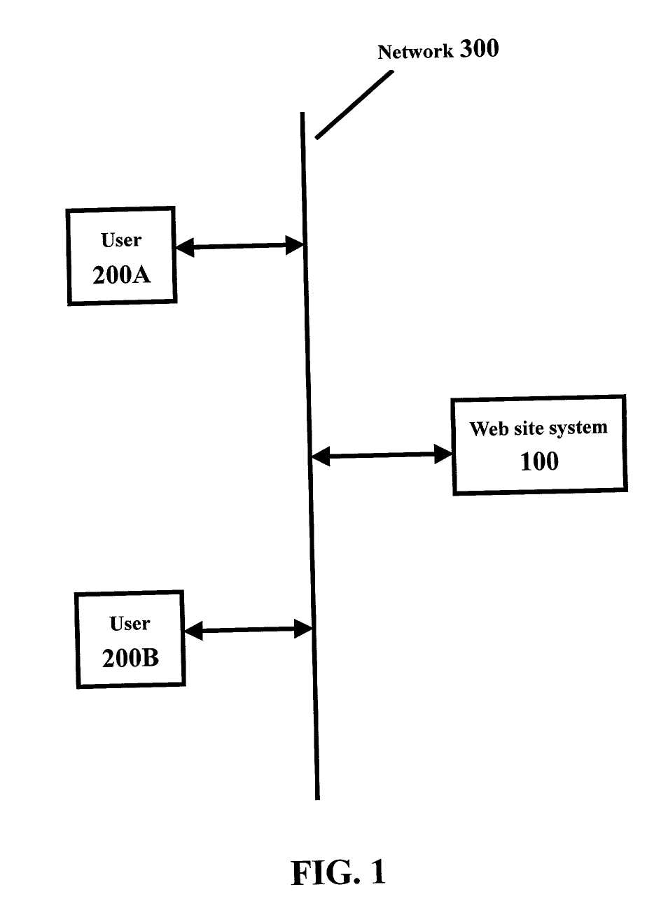

Refer to FIG. 1 for an environment of the invention. There are a plurality of users 200A and 200B who may logon and access a Web site system 100 through a communication link (such as a network 300) to participate network-aided instruction activities.

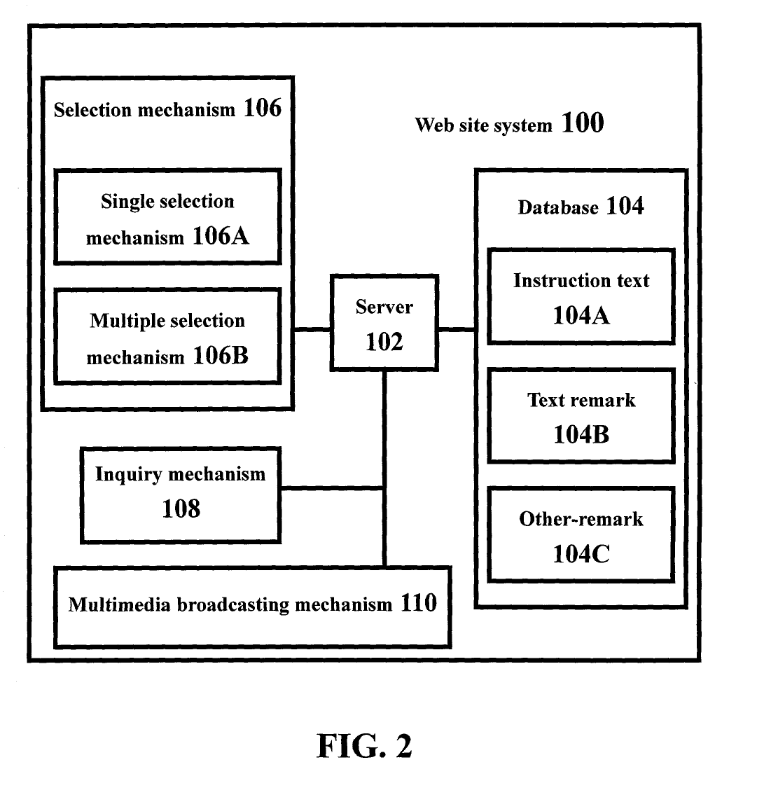

Refer to FIG. 2 for the architecture of the Web site system of the invention. The Web site system 100 consists of at least a server 102, a database 104, a selection mechanism 106, an inquiry mechanism 108, and a multimedia broadcasting mechanism 110.

The database 104 can store at least one instruction text 104A and one text remark 104B. The instruction text 104A is an instruction document such as contents of teaching materials or textbooks, and can include at least one text unit. That is to say that a plurality of text units can be grouped to form the instruction text and can be transmitted in Web page formats through the network to user ends. On the other hand, the text remark 104B is key point explanation of the instruction text 104A. in the present invention, users may select the text unit or a keyword on the Web page of the instruction text, and can designate a remark category to search and retrieve required remarks from the text remarks 104B. In addition, the database 104 may further include other-remarks 104C to provide users required remarks when searching and inquiring other instructions.

The selection mechanism 106 includes a single selection mechanism 106A and a multiple selection mechanism 106B. The selection mechanism 106 may retrieve identification data of the text unit or character strings of the keyword selected by users from the instruction text 104A, and change style attributes of the selected text unit or keyword to highlight selected conditions of the text unit or keyword. The single selection mechanism 106A allows users to select only one text unit or one keyword at a time. The multiple selection mechanism 106B allows users to select multiple text units or keywords at a time, or concurrently single select (multiple selections) a text unit and single select (multiple selections) a keyword. This mechanism may be made by employing Microsoft's Vbscript language which can be downloaded to user ends along with the Web pages of the instruction text.

The inquiry mechanism 108 is used to receive the identification data of the text unit or keyword character strings obtained by the selection mechanism 106 and based on user's designated remark category, and can employ database inquiry techniques to search and inquire related remarks in the text remark 104B. This mechanism 108 may be made by employing Microsoft's ActiveX Data Objects 2.5 Library and can be installed in the Web site system end.

The multimedia broadcasting mechanism 110 is used for broadcasting multimedia objects. In the event that the instruction text 104A or text remark 104B includes multimedia objects, this mechanism 110 may be used to broadcast the multimedia objects including audio signals, animations, films or the likes. This mechanism 110 may be made by employing Microsoft's Visual Basic language and adopt Lib “winmm.dll” multimedia function library of API (Application Programming Interface) and MCI (Media Control Interface) commands to setup ActiveX objects. To broadcast special multimedia objects, corresponding MCI driver programs must be obtained and used. This mechanism 110 can also be downloaded to user ends.

The instruction text 104A mentioned above consists of a plurality of text units. Each text unit has an identification data and can be stored respectively in a Table of the database. Related data of every text unit is a record in the Table. The record consists of a plurality of fields. Each field contains identification data (MTid) of the text unit, contents or content index of the text unit, etc. The structure of text format is shown in Table 1. The text units are arranged according to MTid sequence and are presented in their original formats through the network to the user ends.

The text remark 104B is the remark of the text unit of the instruction text 104A or the remark of the keyword of the instruction text 104A. The text remark 104B includes at least one text remark record. Each record consists of a plurality of fields. Each field includes identification data (CMid) of the remark, contents or content index of the remark, content properties, etc. The structure of the remark format is shown in Table 2.

The identification data (CMid) of every record in the text remark 104B and the identification data (MTid) of the text unit or keyword in the instruction text 104A are linked to provide users remarks for inquiring the text unit or keyword. In the event that the instruction text is English teaching materials and the text unit is every sentence of the teaching materials, the text unit related remarks may be divided to different categories, such as translation of the sentence, grammar concept related to the content of the sentence, test questions related to the meaning of the sentence, or instruction activities related to the content of the sentence, etc. The keyword is a single word or phrase of every sentence. Remark category of the keyword may be meaning of the word or phrase, pronunciation, root, prefix or test questions, etc. The structure of the linking format is shown in Table 3, in which the Type is the category of the remark.

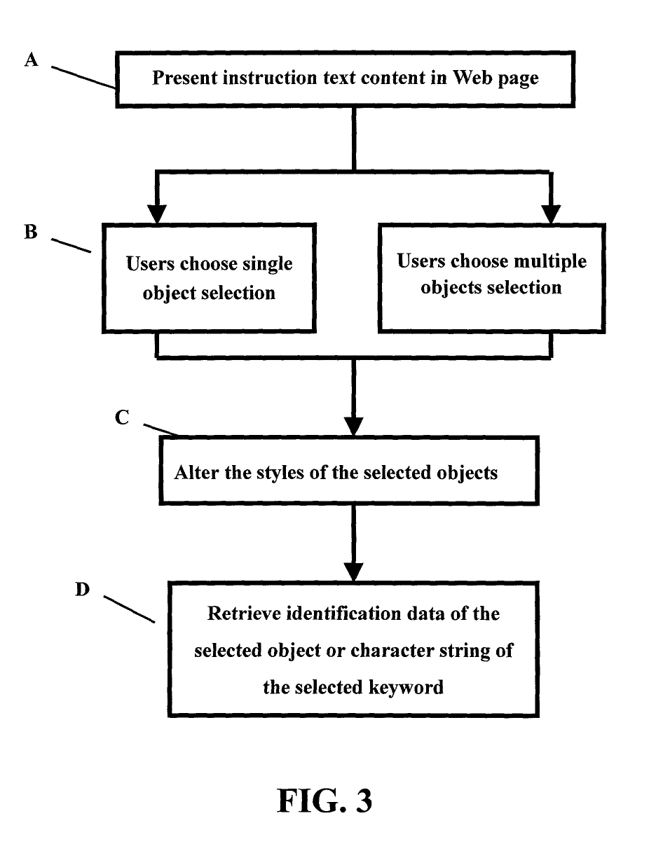

The selection mechanism 106 can retrieve the identification data of the text unit users selected or a character string of the selected keyword. The selection mechanism 106 consists of a single selection mechanism 106A and a multiple selection mechanism 106B. The flow chart for selection is shown in FIG. 3.

Step A: Instruction text is presented at user ends in Web page formats. The instruction text includes a plurality of text units and each of them has an identification data.

Step B: Users may select a single text unit or multiple text units, or select a single keyword or multiple keywords, or simultaneously select single (or multiple) text unit and single (or multiple) keyword.

Step C: Alter style attributes of the selected text unit or keyword, such as attributes of color or backgrounds to highlight the text unit or keyword being selected.

Step D: Through HTML object models, retrieve the identification data of the selected text unit or character string of the selected keyword.

The inquiry mechanism 108 may receive remark category designated by the user and the identification data of the selected text unit or character string of the selected keyword obtained by the selection mechanism 106, and may employ database inquiry techniques to search and inquire remarks required by the user from the text remark 104B.

Taking English teaching materials as an example, if the text unit is every single sentence in the content of the teaching materials, and if a user selects one sentence and designates the remark category of the inquiry to be grammar concept of the sentence, then the inquiry mechanism 108 receives the identification code (MTid) of the sentence obtained by the single selection mechanism 106A, searches corresponding remark identification data (CMid) from Table 3 according to the remark type, and searches Table 2 to retrieve the corresponding content of the CMid that is the remark content of the grammar concept of the sentence. If the user designates the remark category of the inquiry to be test questions related to the grammar of the sentence, then the corresponding content of the CMid is the content of test questions related to the grammar of the sentence.

The database may further include other remark 104C to provide users remarks required for inquiring other instructions. The other remark 104C includes at least one record of the other remark. If the other remark 104C includes a test question library, the structure of the remark format is shown in Table 4. TPid is the identification code of the test question library, content is the contents of the topic, prop1 is the uniformed code of the grammar related to the test question, and prop2 is the original word related to the test question. If the user chooses the multiple selection mechanism 106B to select a sentence and a single word and designates inquiry for the related grammar of the sentence and related test questions of the single word, the inquiry mechanism 108 retrieves the identification code MTid of the sentence and character string Keyword of the single word through the multiple selection mechanism 106B, and retrieves from Table 5 identification data CMid_{—}1 and CMid_{—}2 related to remark records based on the MTid and the Keyword. Table 5 and Table 3 have the same properties and are linking forms. The remark content of CMid_{—}1 is the grammar concept related to the sentence, while the remark content of CMid_{—}2 is remark of the word related to the keyword. The structure of the remark form is shown in Table 6. Table 6 and Table 2 have same properties and are remark forms. In the Table 6, if prop1 corresponding to Cmid_{—}1 is the grammar uniformed code of the grammar concept, and prop1 corresponding to CMid_{—}2 is the original of the word, then related test questions may be retrieved from Table 4. The content of the retrieved test questions relates to the grammar concept of the sentence and also relates to the word.

Thus, users may not only randomly select any object in the instruction text and designate remark category of inquiry (such as designating inquiry for grammar concept or test question set forth above), but may also freely designate inquiry scope (such as designating inquiry for a specific test question library) to search required remarks. Moreover, users may not only select a single object for inquiry, but may also make multiple selection and process cross inquiry or other type of inquiry allowable for other databases to search and inquire required remarks.

In addition, users may not only select objects on the text Web pages and request to inquire remark contents, but may also select objects on the remark Web pages to request inquiry of the remarks related to the objects. This can be accomplished because the selection mechanism 106 can retrieve the identification data of the objects on the remark Web pages, retrieve properties of the objects from Table 2, Table 4 or Table 6, and then search and retrieve other remark contents from the text remark 104B or other remark 104C based on the properties (such as prop 1).

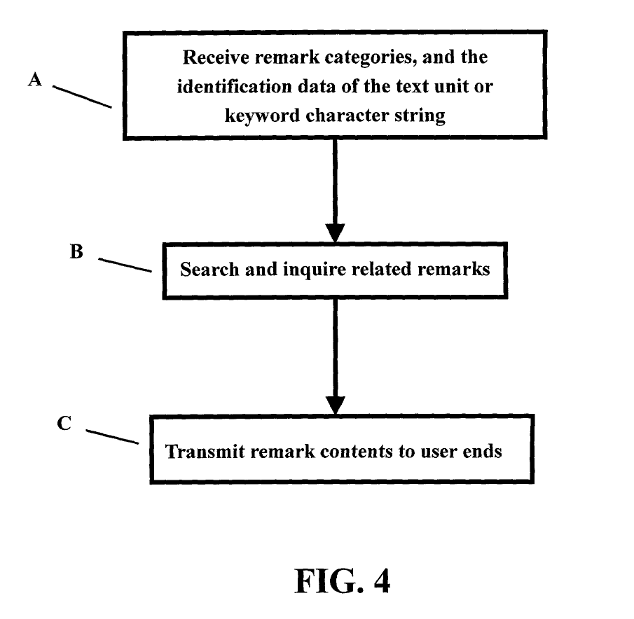

The inquiry process flow of the inquiry mechanism 108 is shown in FIG. 4, details are as follows.

Step A: Receive from user ends the remark category or identification data (or keyword character string) of the text unit retrieved by the selection mechanism 106.

Step B: Based on the remark category and employing database, inquiry techniques search and retrieve remarks related to the identification data or keyword character string from the text remark 104B.

Step C: Present the retrieved remark content in Web page formats through the network to the user ends.

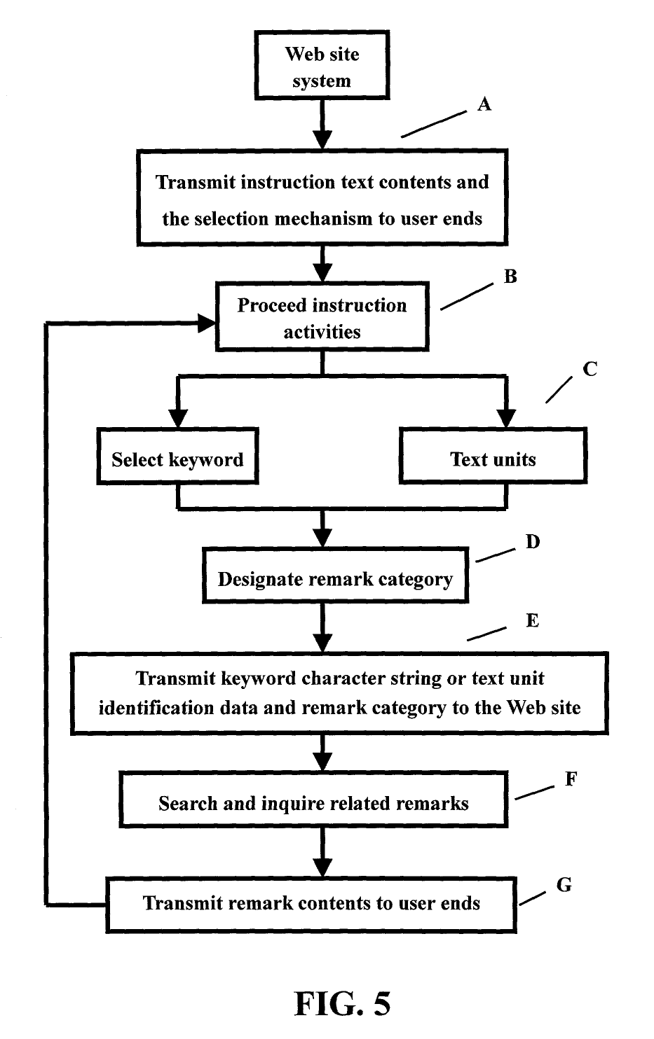

Referring now to FIG. 5, the process flow of the method of the invention is shown as follows.

Step A: Instruction text 104A is transmitted in Web pages formats through the network to a user end and the selection mechanism 106 is downloaded along the Web pages to the user end.

Step B: The user proceeds to instruction activities according to the instruction text presenting on the Web pages.

Step C: The user, based on instruction requirements, selects a keyword or text unit on the Web pages, and the selection mechanism 106 retrieves keyword character string or identification data of the text unit.

Step D: The user designates remark category.

Step E: Transmit the keyword character string (or identification data of the text unit) and the designated remark category to the Web site system end.

Step F: The Web site system end, through the inquiry mechanism 108, receives the keyword character string (or the identification data of the text unit), and searches and retrieves related remarks from the text remark 104B based on the remark category.

Step G: The web site system end transmits the retrieved remark content in Web page formats through the network to the user end to facilitate instruction-aided activities.

The multiple selection mechanism 106B of the selection mechanism 106 may also be adopted for general office software (such as document process software, spreadsheet software, database software, presentation software, or electronic mail software, and the likes), or electronic book software, Web page browsers, CAI software, electronic dictionary reading software or patch book software of operating system. While the patch book of existing operating systems has multiple selection function, but we cannot tell which objects are the selected ones. Because the software mentioned above can generate only one selection object at a time for one document, the multiple selection mechanism 106B of the invention can change style attributes of multiple selected objects and highlights selected conditions of multiple selected objects.

The method of the invention may also be implemented through a software program. If the software program including the selection mechanism and the inquiry mechanism is linked to a database and if the database has stored contents of instruction texts, text remarks and other-remarks, the software program becomes a container of the instruction texts. Users may search and inquire related remarks through the selection mechanism and the inquiry mechanism, and the retrieved remark contents also are presented in the container.

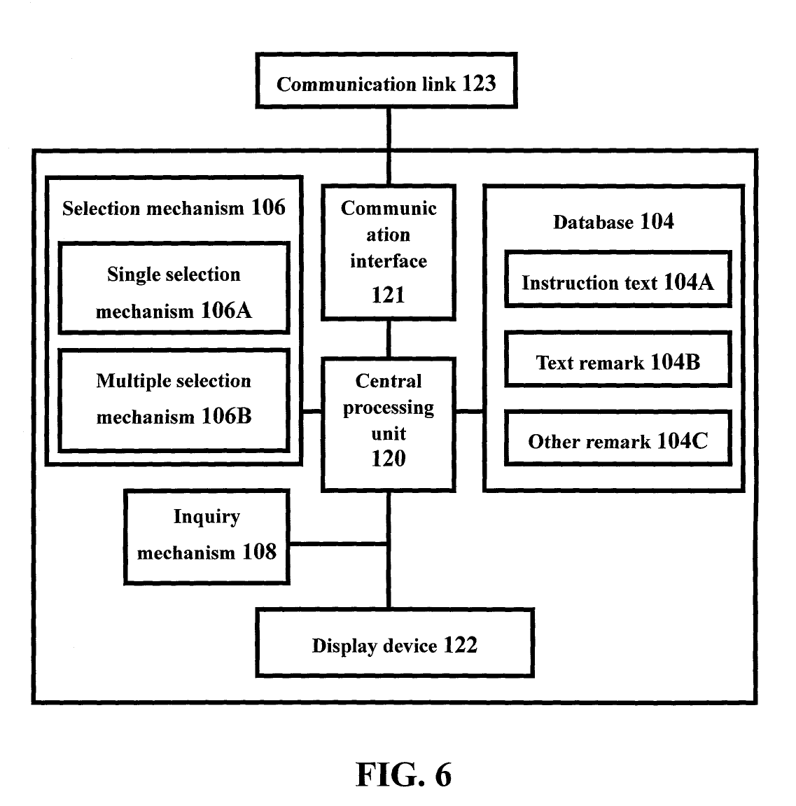

In addition, the invention may also be implemented through an apparatus (as shown in FIG. 6). If the apparatus includes a central processing unit 120, a display device 122 and a database 104, if the apparatus includes a selection mechanism 106 and an inquiry mechanism 108, and if the database 104 has stored contents of instruction text 104A, text remarks 104B and other-remarks 104C; the instruction text 104A is displayed on the display device 122, users may search and inquire related remarks through the selection mechanism 106 and the inquiry mechanism 108, and the retrieved remark contents are also presented on the display device 122. If the apparatus further includes a communication interface 121 connected to a communication link 123, then all contents in the database 104 may be downloaded to process instruction-aided activities through the communication interface 121. Or, through the communication interface 121 to download the instruction text 104A and the selection mechanism 106, the instruction text 104A may be presented on the display device 122. Users may employ the selection mechanism 106 and through the communication interface 121 to call the inquiry mechanism 108 to search and inquire related remarks. Obtained remark contents are presented on the display device 122 through the communication interface 121.

In fact, the system and method of the invention cannot only be used on network-aided instructions, but also be adopted for publishing digital data on networks. In such an environment, the database stores contents for publishing, the Web pages are the carrier of the contents, and networks are distribution channels for publishing. Nowadays, there are thousands of Wet sites that can provide a wide range of information. So, we can say that information is flooding everywhere. To engage in network publishing in such an information explosive environment, the critical task is no longer how to present a large amount of information, but rather on how to shield or mask less important information, and on how to timely present required information to users. As Web pages provide a digital environment that has “non-linear” sequencing and “interactive” characteristics, presentation of information may be initiated by a theme, and all related contents may be linked and retrieved. The text units and keywords mentioned in the invention can play the roles of linking, and based on inquiry of identification data of the text units and keyword character string to retrieve related contents.

While the preferred embodiments of the invention have been set forth for purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

TABLE 1

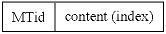

TABLE 2

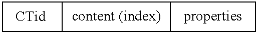

TABLE 3

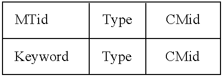

TABLE 4

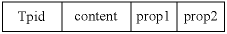

TABLE 5

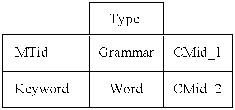

TABLE 6

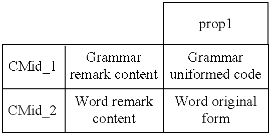

What is claimed is:

1. A method for network-aided instruction comprising at least steps of:
presenting an instruction text in a container at a user end, the instruction text being an instruction document including at least one text unit stored in database;
providing a text remark which includes at least one text remark record stored in the database, the text remark record being selectively linked to the text unit or a keyword of the instruction text; and
selecting the text unit or the keyword by the user in the instruction text;
wherein the container includes (or retrieves) a selection mechanism which retrieves identification data of the text unit or a character string of the keyword selected by the user and alters style attributes of the text unit or the keyword to highlight selected conditions, the selection mechanism including at least a single selection mechanism; and
wherein the container further includes (or retrieves) an inquiry mechanism which receives the identification data of the text unit or the character string of the keyword obtained by the selection mechanism, and searches remarks related to the text remark in the database; contents of the searched and obtained remarks being presented in the container at the user end.

2. The method of claim 1 further including the user designating a remark category and the inquiry mechanism receiving the identification data of the text unit or the character string of the keyword obtained by the selection mechanism, and based on the designated remark category searches remarks related to the text remark in the database.

3. The method of claim 1 further including other-remarks which include at least one other-remarks record stored in the database, the other-remarks record being linked to category properties of the text remark record.

4. The method of claim 1, wherein the selection mechanism further includes a multiple selection mechanism which retrieves identification data of a plurality of text units or character strings of a plurality of keywords selected by the user and alters style attributes of the text units or the keywords to highlight selected conditions.

5. The method of claim 1 is being used for publishing digital information on networks, the instruction text further including a general document.

6. The method of claim 1, wherein the container is a software program.

7. The method of claim 1, wherein the container is stored in a computer readable storage medium.

8. The method of claim 1, wherein the container and the database are stored in a computer readable storage medium.

9. The method of claim 6, wherein the software program selectively includes an electronic book reading software program or an electronic dictionary reading software program.

10. The method of claim 6, wherein the software program includes an instruction-aided software program.

11. The method of claim 6, wherein the software program is selected from the group of a document process software, a spreadsheet software, a database software, a presentation software, or an electronic mail software.

12. The method of claim 8, wherein the computer readable storage medium includes an optical disk for computer aid instruction (CAI).

13. A Web site system for providing network-aided instruction to allow a plurality of users to participate network-aided instruction activities through communication links, the Web site system comprising at least:
a server;
a database storing at least one instruction text and one text remark, the instruction text being an instruction document including at least one text unit, the text remark including at least one text remark record, the text remark record being linked to the text unit or a keyword in the instruction text, the instruction text being allowed to present at a user end through the communication links, the user being allowed to select the text unit in the instruction text or the keyword to search and inquire related remarks;
a selection mechanism which is able to be downloaded to the user end, the selection mechanism retrieving identification data of the text unit or a character string of the keyword selected by the user and alters style attributes of the text unit or the keyword to highlight selected conditions, the selection mechanism including at least a single selection mechanism; and
an inquiry mechanism which through the communication links receives the identification data of the text unit or the character string of the keyword obtained by the selection mechanism, and searches remarks related to the text remark in the database; contents of the searched and obtained remark being presented to the user end through the communication links.

14. The Web site system of claim 13 further including the user designating a remark category, and the inquiry mechanism through the communication links receiving the identification data of the text unit or the character string of the keyword obtained by the selection mechanism, and based on the designated remark category searches remarks related to the text remark in the database.

15. The Web site system of claim 13, wherein the database further includes other-remarks which include at least one other-remarks record stored in the database, the other-remarks record being linked to category properties of the text remark record.

16. The Web site system of claim 13, wherein the selection mechanism further include a multiple selection mechanism which retrieves identification data of a plurality of text units or character strings of a plurality of keywords selected by the user and alters style attributes of the text units or the keywords to highlight selected conditions.

17. The Web site system of claim 13 is being used for publishing digital information on networks, the instruction text further including a general document.

18. An instruction-assisting apparatus, comprising at least:
a central processing unit;
a display device;
a communication link; the communication link being connected to at least a database, storing at least one instruction text and one text remark, the instruction text being an instruction document including at least one text unit, the text remark including at least one text remark record, the text remark record being linked to the text unit or a keyword in the instruction text, the instruction text being allowed to present on the display device to allow a user to select the text unit in the instruction text or the keyword to search and inquire related remarks;
a selection mechanism for retrieving identification data of the text unit or a character string of the keyword selected by the user and alters style attributes of the text unit or the keyword to highlight selected conditions, the selection mechanism including at least a single selection mechanism; and
an inquiry mechanism which receives the identification data of the text unit or the character string of the keyword obtained by the selection mechanism, and, through the communication link, searches remarks related to the text remarks in the database; contents of the searched and obtained remarks being presented on the display device.

19. The instruction-assisting apparatus of claim 18 further including the user designating a remark category, and the inquiry mechanism receiving the identification data of the text unit or the character string of the keyword obtained by the selection mechanism, and based on the designated remark category searches remarks related to the text remark in the database.

20. The instruction-assisting apparatus of claim 18, wherein the database further includes other-remarks which include at least one other-remarks record stored in the database, the other-remarks record being linked to category properties of the text remark record.

21. The instruction-assisting apparatus of claim 18, wherein the selection mechanism further include a multiple selection mechanism which retrieves identification data of a plurality of text units or character strings of a plurality of keywords selected by the user and alters style attributes of the text units or the keywords to highlight selected conditions.

22. The instruction-assisting apparatus of claim 18, wherein the instruction text further includes a general document.

23. The instruction-assisting apparatus of claim 18, wherein the apparatus includes either an electronic book or an electronic dictionary.

24. The instruction-assisting apparatus of claim 18, wherein the apparatus includes a personal digital assistant (PDA).
